(19) United States
(12) Patent Application Publication
(10) Pub. No.: US 2019/0266674 A1
(43) Pub. Date: Aug. 29, 2019

(54) Systems and Methods to Hedge the Risk of Loss Associated With the Imminent, Unpredictable and Uncontrollable Characteristics Inherent In Catastrophic Events

(71) Applicant: Michael Kownacki, Mahwah, NJ (US)

(72) Inventor: Michael Kownacki, Mahwah, NJ (US)

(21) Appl. No.: 15/866,433

(22) Filed: Jan. 9, 2018

(51) Int. Cl. G06Q 40/08; G06Q 40/06; G06Q 50/26; G06Q 50/16

(52) U.S. Cl. CPC G06Q 40/08; G06Q 50/16; G06Q 50/26; G06Q 40/06

(57) ABSTRACT

Systems and Methods to Hedge the Risk of Loss Associated With the Imminent, Unpredictable and Uncontrollable Characteristics Inherent In Catastrophic Events is a technology that addresses the imminent, unpredictable and uncontrollable innate characteristics that are inherent in catastrophic events, those that occur in a very quick time, that which is unpredictable with a high degree of certainty, that which behaves in an unforeseeable way, and that of which is unmanageable, a means, in the time sensitive environment, for one, who desires the ability to obtain protection from the risk of loss to a geographic location, due to such innate characteristics that are inherent in catastrophic events, and another, who desires the ability to incur exposure to such risk of loss to a geographic location, due to the innate characteristics of catastrophic events; such technology, comprises, real-time, near real-time or most recently available data, observations, estimations, projections, calculations, analysis, imagery and measurements associated with the imminent, unpredictable and uncontrollable innate characteristics that are inherent in catastrophic events, the Planet Earth's oceans, weather and environment, and the weather and the activity of our Solar System, to market, evaluate, analyze, monitor, value, manage and obtain the desired risk of loss positions.

### CROSS-REFERENCE TO RELATED APPLICATIONS

This Nonprovisional patent application for Systems and Methods to Hedge the Risk of Loss Associated With the Imminent, Unpredictable and Uncontrollable Characteristics Inherent In Catastrophic Events is claiming priority and the benefit of one prior-filed, Provisional Patent Application Ser. No. 62/443,940, filed on Jan. 9, 2017, titled, System and Methods to Hedge the Imminent, Unpredictable and Uncontrollable Risk of Loss, by the Inventor and Applicant, Michael Kownacki.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to Systems and Methods to Hedge the Risk of Loss Associated With the Imminent, Unpredictable and Uncontrollable Characteristics Inherent In Catastrophic Events, the invention.

Once catastrophic events develop, they may take on many states very quickly. Catastrophic events are both natural and man-made, resulting in extraordinary levels of damage and loss and may exhibit imminent, unpredictable and uncontrollable characteristics. Catastrophic events that exhibits such characteristics, that may present a risk of loss, may include, storm systems, tornadoes, tsunamis, wildfires, earthquakes, floods, volcanic eruptions, acts of terrorism, acts of war and other disasters. Catastrophic events, such as storm systems, may include tropical storms, tropical cyclones, hurricanes, typhoons, floods, blizzards, hail storms, ice storms, dust storms, cyclonic storms, tropical depressions, post-tropical cyclones, cyclones, high winds, wind storms and storm surge.

Preliminary estimates for global economic losses due to catastrophic events in 2017 are expected to exceed an astronomical, one-half of a trillion dollars, two and a half times that of 2016 and more than four times that of 2015. Globally, more than 11 000 people have died as a result of catastrophic events in 2017.

Catastrophe events in 2017 included 3 very destructive Hurricanes, Harvey, Irma and Maria, causing significant damage that stretched from the Texas coast to Florida to the Caribbean, including Puerto Rico, major wildfires in California, some of which are still raging in Southern California, a number of server convective storms, accompanied with tornadoes and hail and high winds causing unprecedented loss in the United States. It is estimated that Hurricanes Harvey, Irma and Maria, each had more than two trillion U.S. dollars of assets in their paths. Globally, catastrophic events inflicted major damage and loss as two powerful earthquakes that rocked regions of Mexico, tropical cyclone Debbie and extreme winds and flooding ravaged Australia, severe flooding in South East Asia took the lives of about 2,700 people and cold snaps and heat waves in Europe caused billions of dollars in damage in the agricultural sector.

The past meteorological year (from December of 2016 through November of 2017) was the second warmest period since modern global temperature records begun in the 1880s and scientific studies on global warming predict that, certain catastrophic events, such as storm systems, may be more powerful by the end of the 21^{st} century.

Characteristics of catastrophic events, such as the imminent and uncontrollable state, once present, immediately represents a risk of loss, and the technology available to forecast and model catastrophic events, such as technological predictive models for storm systems, may be able to monitor the catastrophic events' location, make predictions about the storm systems' potential direction, and make predictions about an increase or decrease in the strength or intensity of a storm systems' development over time, however inexact, but such technology is greatly compromised by the imminent, unpredictable and uncontrollable characteristics inherent in catastrophic events.

Therefore, there exists a requirement for new and more efficient and effective systems and methods to hedge the risk of loss due to the imminent, unpredictable and uncontrollable characteristics inherent in catastrophic events.

### SUMMARY OF THE INVENTION

It is therefore an object of the invention to provide systems and methods to hedge the risk of loss associated with catastrophic events. Systems and Methods to Hedge the Risk of Loss Associated With the Imminent, Unpredictable and Uncontrollable Characteristics Inherent In Catastrophic Events, is a useful tool for one seeking the most time sensitive and efficient manner to eliminate or mitigate the possibility of the risk of loss and one willing to incur the possibility of the risk of loss, due to catastrophic events.

This and other objects are accomplished in accordance with the principles of the invention by providing systems and methods that enable transactions to hedge the risk of loss associated with catastrophic events.

### BRIEF DESCRIPTION OF DRAWINGS

Features of the invention, Systems and Methods to Hedge the Risk of Loss Associated With the Imminent, Unpredictable and Uncontrollable Characteristics Inherent In Catastrophic Events, will be more apparent from the following description taken in conjunction with the accompanying drawings, in which reference characters refer to parts throughout, or any similar combination of the same, satisfactory to execute and perform the methods required as described.

FIG. 1 is a diagram illustrating a proposed transaction between a purchaser of protection and a counterparty, a provider of protection, in accordance with certain embodiments of the invention.

FIG. 2 is a diagram illustrating a risk of loss position that a provider of protection may undertake in a USD 00.01 to USD 100,000,000.00 risk of loss position with a purchaser of protection that may have a risk of loss amount of USD 1 billion, in accordance with certain embodiments of the invention.

FIG. 3 is a diagram illustrating a risk of loss position that a provider of protection may undertake in a USD 100,000,000.01 to USD 200,000,000.00 risk of loss position to a purchaser of protection that may have a risk of loss amount of USD 1 billion, in accordance with certain embodiments of the invention.

FIG. 4 is a diagram illustrating a USD 1 billion risk of loss position of the purchaser of protections' liability portfolio, each liability of such portfolio with an average of USD 1 million, that a provider of protection may undertake in a USD 250,000.01 to USD 1,000,000.00 risk of loss position for each liability of an average of USD 1 million, in accordance with certain embodiments of the invention.

FIG. 5 is a diagram illustrating a risk of loss position that a provider of protection may undertake in a USD 200,000,000.01 to USD 300,000,000.00 risk of loss position to a purchaser of protection that has a risk of loss position in the amount of USD 1 billion, in accordance with certain embodiments of the invention.

FIG. 6 is a diagram illustrating a risk of loss position that a provider of protection may undertake in a USD 10,000,000,000.01 to USD 35,000,000,000.00 risk of loss position to a purchaser of protection that has a risk of loss position in the amount of USD 100,000,000,000.00, in accordance with certain embodiments of the invention.

FIG. 7 is a block diagram of a system that may be used to implement the processes and functions of certain embodiments of the invention.

FIG. 8 is a block diagram of computer systems and its components that may be used to implement the processes and functions of certain embodiments of the invention.

FIG. 9 is a diagram illustrating a predetermined USD 1,000,000,000.00 risk of loss position in which a provider of protection may undertake the risk of loss of a pre-determined amount that is predicated on simply some occurrence of specific catastrophic event.

FIG. 10 is a block diagram of a system that may be used to implement the processes and functions of call option based upon the underlying instrument and invention.

### DESCRIPTION OF THE INVENTION

Systems and Methods to Hedge the Risk of Loss Associated With the Imminent, Unpredictable and Uncontrollable Characteristics Inherent In Catastrophic Events is a useful tool for one seeking the most time sensitive and efficient manner to hedge the risk of loss, whereby, the risk of loss is eliminated, in its entirety or in part, or mitigated, a hedge, and one willing to incur the possibility of the risk of loss, in its entirety or in part, in exchange for an economic reward, by utilizing this risk of loss transfer tool that provides the timely execution necessary to address the risk of loss due to the innate characteristics of catastrophic events.

Risk of loss due to catastrophic events may be the probability of loss due to the actual damage to, or the actual loss of tangible value, or the actual destruction of assets or property, or the disaster and/or recovery assistance provided to impacted entities, as a direct result of catastrophic events, that may result in the financial burden of bearing the monetary cost associated with the repair or replacement of the loss, or asset, or property, or the disaster and/or recovery assistance provided, or the risk of loss may be a pre-determined amount that may be predicated on simply some occurrence of specific catastrophic events.

The imminent, unpredictable and uncontrollable innate characteristics that catastrophic events present, may be, occurring in a very quick time, that which is unpredictable with a high degree of certainty, that of which behaves in an unforeseeable way, and that of which is unmanageable.

Catastrophic events that may possess innate characteristics that present a risk of loss may include storm systems, including, tropical storms, tropical cyclones, hurricanes, typhoons, floods, blizzards, hail storms, ice storms, dust storms, cyclonic storms, tropical depressions, post-tropical cyclones, cyclones, winds or high winds, wind storms, and storm surge, as well as, tornadoes, tsunamis, wildfires, earthquakes, volcanic eruptions, acts of terrorism, acts of war and other types of threats and disasters.

The imminent, unpredictable and uncontrollable characteristics of catastrophic events present uncertainty and may create many different views as to the risk of loss. Accordingly, in a time sensitive environment, a purchaser of protection, based upon a view, may desire to eliminate the possibility of incurring any risk of loss, in its entirety, or in part, or reduce the severity of any risk of loss, by eliminating such risk of loss in part. Conversely, based upon a different view, in a time sensitive environment, a provider of protection may desire to increase exposure to the risk of loss, in its entirety, or in part, and thereby earning an economic award, a risk protection premium.

Such provider of protection and such purchaser of protection may be any acceptable entity deemed appropriate and approved to transact Systems and Methods to Hedge the Risk of Loss Associated With the Imminent, Unpredictable and Uncontrollable Characteristics Inherent In Catastrophic Events, including financial institutions, investment funds, insurance companies, risk traders, re-insurance companies, speculators, the insured, the self-insured, the uninsured, municipal governments, county governments, state governments, federal governments, and/or their sponsored agencies, and any other suitable counterparties, or entities, whether domestic or international, who may desire to execute such transactions in a timely manner through an index, indices, an exchange, or a trading desk, to sell, to buy, and to trade the risk of loss.

Systems and Methods to Hedge the Risk of Loss Associated With the Imminent, Unpredictable and Uncontrollable Characteristics Inherent In Catastrophic Events, whereby the risk of loss, which at least one purchaser of protection may seek to eliminate or mitigate, and at least one provider of protection may seek to undertake and transact, by way of the invention, may be identified as a quantifiable degree, in preferred embodiment, as a currency, and may include its fractional unit, should it exist, of various configurations and compositions, related to the risk of loss.

Systems and Methods to Hedge the Risk of Loss Associated With the Imminent, Unpredictable and Uncontrollable Characteristics Inherent In Catastrophic Events, in its preferred embodiment, the instrument transacted, may reference exposure to an aggregate of asset classes, or one or more specific asset classes that may include, residential real estate, commercial real estate, personal property, municipal, county, state or federal government infrastructure, disaster and/or recovery assistance; may reference a specifically defined name and/or identification code associated with a catastrophic event, such as a specific name of a storm system or wildfire; may reference a precisely defined and delineated geographic location, such as the legal limits of a city; may reference an asset or property or structure by a complete address, identified by street address, city, county, state, zip code, and country; may reference a precise geographic location; an asset or property; specific infrastructure; a risk protection premium; an amount of risk of loss, such amount of risk of loss may be identified in a currency amount that the provider of protection is at risk to pay the purchaser of protection, and; may exclude a referenced asset class, specific elements of an asset class, a geographic location, an asset, asset classes, infrastructure, and an asset or property by complete address; and may include an effective date and an expiration date or may expire on a maturity date of the transaction, and; the effective date and expiration date may be expressed as a date and a time.

Should it be determined that the purchaser of protection incurred a loss that the provider of protection may be responsible for, in whole or in part, pursuant to Systems and Methods to Hedge the Risk of Loss Associated With the Imminent, Unpredictable and Uncontrollable Characteristics Inherent In Catastrophic Events, the instrument transacted on the effective date may identify the loss and settlement, may provide for a future settlement method, a future settlement date, and a future settlement payment, that may warrant a payment by the provider of protection to the purchaser of protection for the loss and may be the amount of the risk of loss or may be an amount up to, but not exceeding, the risk of loss, and any such settlement may be processed by a designated clearing operation that provides for such settlement and clearing services, calculating offsetting positions and managing the default risk of the counterparties, which also may include a margin hold and/or a margin call.

Pursuant to Systems and Methods to Hedge the Risk of Loss Associated With the Imminent, Unpredictable and Uncontrollable Characteristics Inherent In Catastrophic Events, whereby the level of risk of loss that may be eliminated, in its entirety or in part, mitigated, by the purchaser of protection and the level of risk of loss incurred by the provider of protection, may be identified as a currency value and/or a percentage and/or other designation and/or name and may include any degree of or all risk of loss, may be a delineated level of risk of loss, identified as a currency value or a percentage or other designation or name. The risk of loss may be an amount determined by a currency value, such as USD 100,000,000.00, and/or by a percentage specifically delineating all risk of loss incurred, or a loss level incurred in relation to the risk of loss incurred or the risk of loss being hedged by the purchaser of protection, may include certain protection levels to the risk of loss, and may exclude certain risks and loss levels that may be applied to each identified risk.

Pursuant to Systems and Methods to Hedge the Risk of Loss Associated With the Imminent, Unpredictable and Uncontrollable Characteristics Inherent In Catastrophic Events, the protection risk premium may be indicative of the catastrophic events, the identified risk, excluded risks, the asset class, assets, the geographic location of an asset or property, and risk level involved in a transaction.

A purchaser of protection and a provider of protection may effect or execute a transaction, in electronic mode or through brokers or traders, including open outcry, on a trading floor, or by way of telephone trading, based upon the name or identification designation of the catastrophic event, the identified risk, the asset class, the risk position, excluded risks, the loss level, settlement event, the settlement amount, and the risk protection premium and by way of a trading desk, a brokerage desk, an exchange, an index, or indices.

Pursuant to Systems and Methods to Hedge the Risk of Loss Associated With the Imminent, Unpredictable and Uncontrollable Characteristics Inherent In Catastrophic Events, as transacted on the effective date, the settlement amount may be the full settlement amount based on the loss incurred or may be periodic, partial payments of the settlement amount, but shall not be more than the risk of loss. In the case of a settlement event, the provider of protection may settle the risk of loss in a settlement amount or a series of settlement amounts that may be due and payable within a certain number of business days following a settlement event through a designated clearing entity.

One of ordinary skill in the art should appreciate that the invention may be practiced in embodiments other than those illustrated herein without departing from the spirit and scope of the invention. For example, purchasers of protection, providers of protection and any other entity, including speculators, wishing to hedge or profit from the instrument or invention, the catastrophic events and the risk of loss, may buy or sell derivatives, such as forwards, and/or futures, and/or vanilla options, and/or call or put option and/or other types of exotic options which may include, barrier options, digital options, average options, compound options, chooser options, swaps, swaptions, caps, floors and collars, whose value is determined by the underlying instrument or invention or certain characteristics of the underlying instrument or invention and may include the catastrophic event and/or risk of loss related to the instrument, or transaction or the invention.

One of ordinary skill in the art should appreciate that the systems and methods of the invention, to provide Systems and Methods to Hedge the Risk of Loss Associated With the Imminent, Unpredictable and Uncontrollable Characteristics Inherent In Catastrophic Events, may be practiced in embodiments other than those illustrated herein without departing from the spirit and scope of the invention.

### DETAILED DESCRIPTION OF THE DRAWINGS

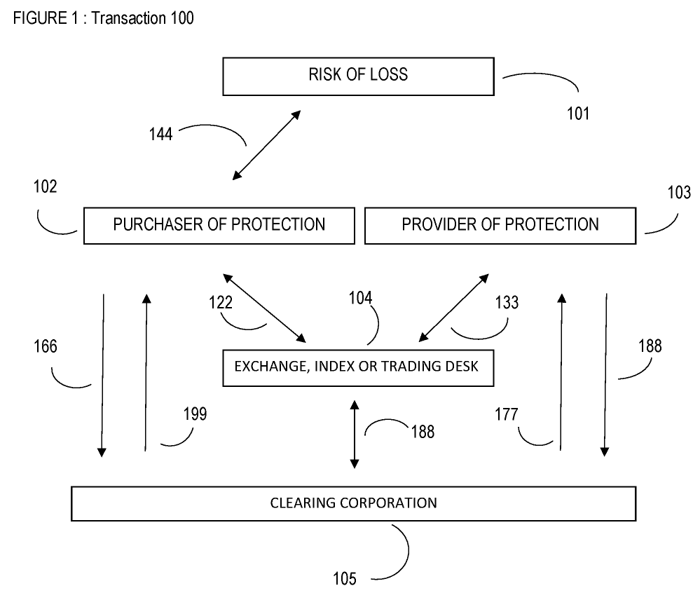

Further details of the invention, Systems and Methods to Hedge the Risk of Loss Associated With the Imminent, Unpredictable and Uncontrollable Characteristics Inherent In Catastrophic Events, are described below with respect to FIG. 1 through FIG. 8.

Referring to FIG. 1, illustrating transaction 100, with at least one purchaser of protection 102 seeking to eliminate or mitigate risk of loss 144 associated with certain risk of loss 101. Risk of loss 144 may reference a category of asset class—residential real estate, commercial real estate, personal property, and private, municipal, state or government infrastructure; may reference a geographic location; may reference the name or identification code of the events; may reference at least one or all of the street addresses, city or cities, state or states, and zip code or zip codes, and country; may reference certain liabilities such as an insurance policy or policies, and; may exclude certain risks, a level of risk, an amount of risk that may be identified as a currency amount that the provider of protection 103 may incur from the purchaser of protection 102 in exchange for a risk protection premium 177. At least one provider of protection 103 that may be willing to undertake certain risk of loss 133 inherent with events 101 in exchange for an acceptable economic reward 177. The provider of protection 103 and the purchaser of protection 102 may be an insurance company, re-insurance company, the insured, the self-insured, third-party risk underwriters, third-party speculators, traders, financial institutions, city, county, state, federal governments, federal government sponsored agencies, and any other suitable counterparties, whether domestic or international, who may execute transaction 100 through exchange, index, indices, or trading desk 104, in which the purchaser of protection 102 desires to hedge the risks 122 and the provider of protection 103 agrees to undertake risks 133, risks that may be of positions of various risk levels, of various degrees of subordination, of various degrees of seniority, of various degrees of risk of loss, that may either be expressed as or quantifiable as a monetary sum, or currency, or a percentage, or other numerical or alphabetical association or description, of various configurations and compositions, related to the risk of loss. In the execution of transaction 100, exchange, index or trading desk 104 may communicate 188 the details of transaction 100 to clearing corporation 105 in order that clearing corporation 105 to clear transaction 100, may process risk protection premium 166, payable by the purchaser of protection 102 and making payment 177 to provider of protection 103 and in the event purchaser of protection 102 incurs a loss, clearing corporation 105 may process payment 188 from provider of protection 103 and making payment settlement 199 to the purchaser of protection 102.

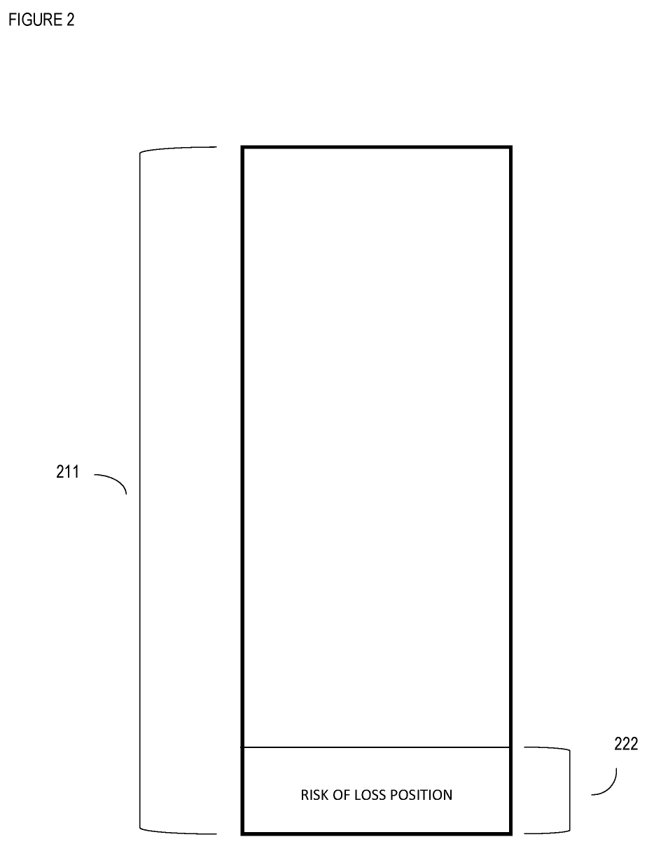

Referring to FIG. 2, a vertical illustration of a USD 1 billion identified risk of loss position 211, that a purchaser of protection may seek to hedge the risk of loss, in whole or in part, in accordance with certain embodiments of the invention. The purchaser of protection may desire to hedge the USD 1 billion of risk of loss 211 and the provider of protection may undertake USD 100 million of the USD 1 billion in risk of loss position 222, in exchange for earning a risk protection premium for undertaking such risk of loss. In the event that it is determined that the purchaser of protection incurs a loss, the provider of protection is responsible for a risk of loss from USD 00.01 up to USD 100,000,000.00, but not in excess of risk of loss position 222, a USD 100 million risk of loss position.

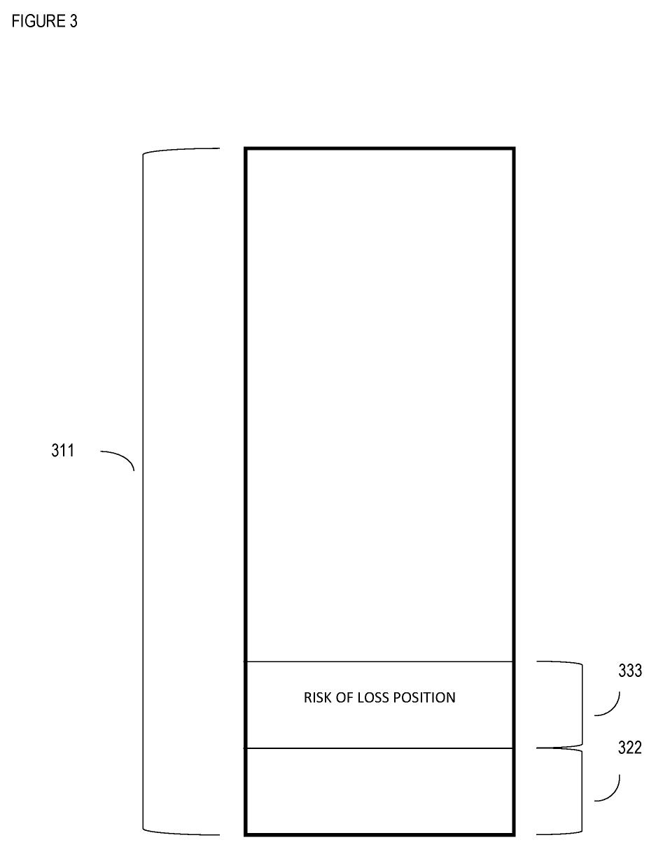

Referring to FIG. 3, a vertical illustration of USD 1 billion identified risk of loss position 311, that a purchaser of protection may seek to hedge the risk of loss, in whole or in part, in accordance with certain embodiments of the invention. The purchaser of protection may desire to hedge the USD 1 billion of risk of loss 311 and the provider of protection may undertake USD 100 million of the USD 1 billion in risk of loss position 333, in exchange for earning a risk protection premium for undertaking such risk of loss. In the event that it is determined that the purchaser of protection incurs a loss, the provider of protection is responsible for any loss in excess of the USD 100 million risk of loss position 322, a risk of loss from USD 100,000,000.01 up to USD 200,000,000.00, but not in excess of the risk of loss position 333, a USD 100 million risk of loss position.

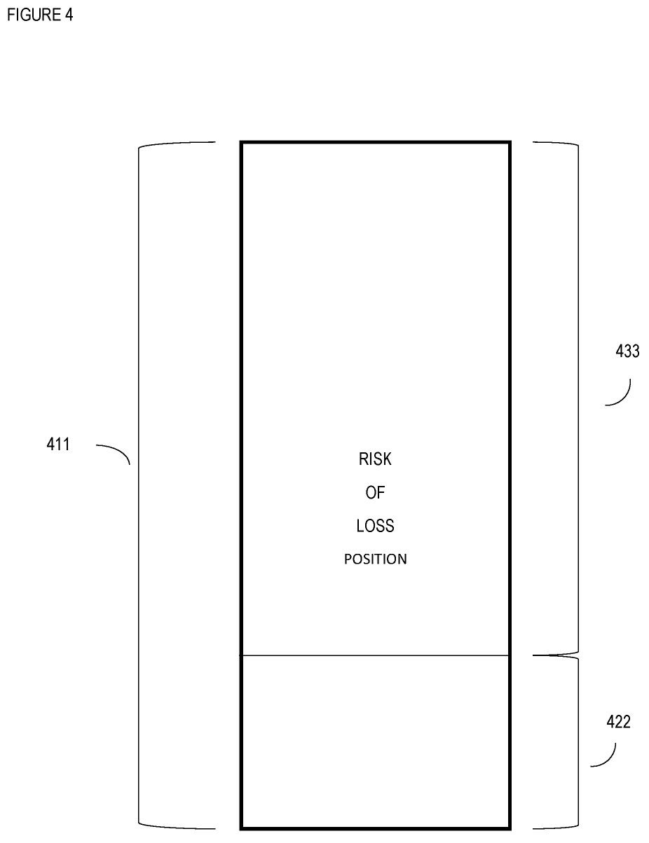

Referring to FIG. 4, a vertical illustration of a USD 1 billion portfolio of identified risk of loss position, in which the average value of each liability in the USD 1 billion portfolio is USD 1 million 411, the purchaser of protection may seek to hedge the risk of loss, in whole or in part, in accordance with certain embodiments of the invention. The purchaser of protection may desire to hedge the risk of loss to the USD 1 billion portfolio comprised of liabilities with an average value of USD 1 million of risk of loss and the provider of protection may undertake a USD 750 million a risk of loss position in a USD 750 thousand risk of loss position 433, for each liability of the average value of USD 1 million in the portfolio, or USD 750,000.00 risk of loss position 433 for each liability of average value of USD 1 million of risk 411. In the event that it is determined that the purchaser of protection incurs a loss, the provider of protection is responsible for any loss in excess of USD 250,000.00 for of each liability of average value of USD 1 million, a risk of loss from USD 250,000.01 up to USD 1,000,000.00 for each liability of average value of USD 1 million.

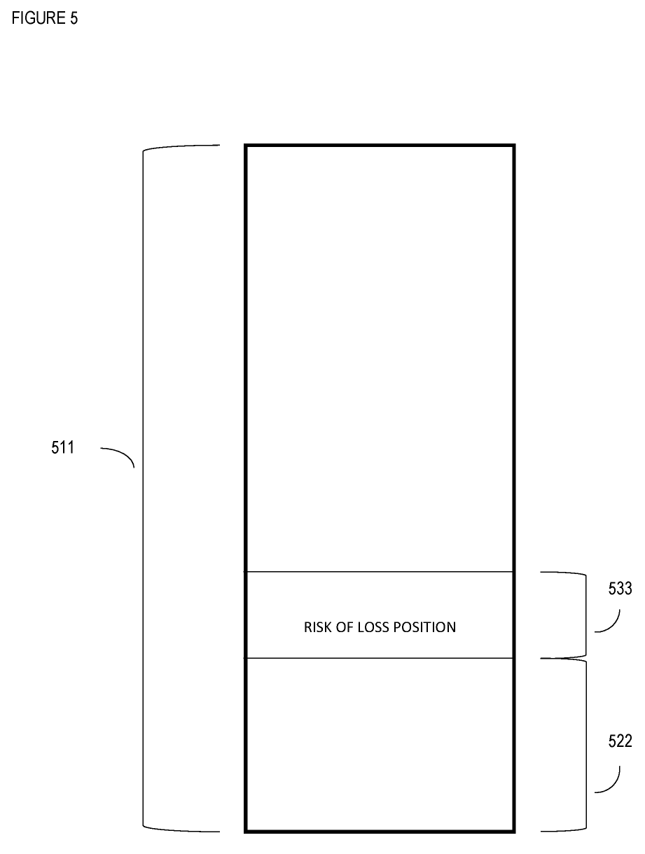

Referring to FIG. 5, a vertical illustration of USD 1 billion of identified risk position 511 that a purchaser of protection may seek to hedge the risk of loss, in whole or in part, in accordance with certain embodiments of the invention. The purchaser of protection may desire to hedge the USD 1 billion of risk of loss 511 and the provider of protection may undertake USD 100 million risk of loss position 533 of the USD 1 billion risk of loss, in exchange for a risk protection premium. In the event that it is determined that the purchaser of protection incurs a loss, the provider of protection is responsible for any risk of loss in excess of risk of loss position 522, a USD 100 million risk of loss position 533, a amount from USD 300,000,000.01 to USD 400,000,000.00, but not in excess of risk of loss position 533, a USD 100 million risk of loss position.

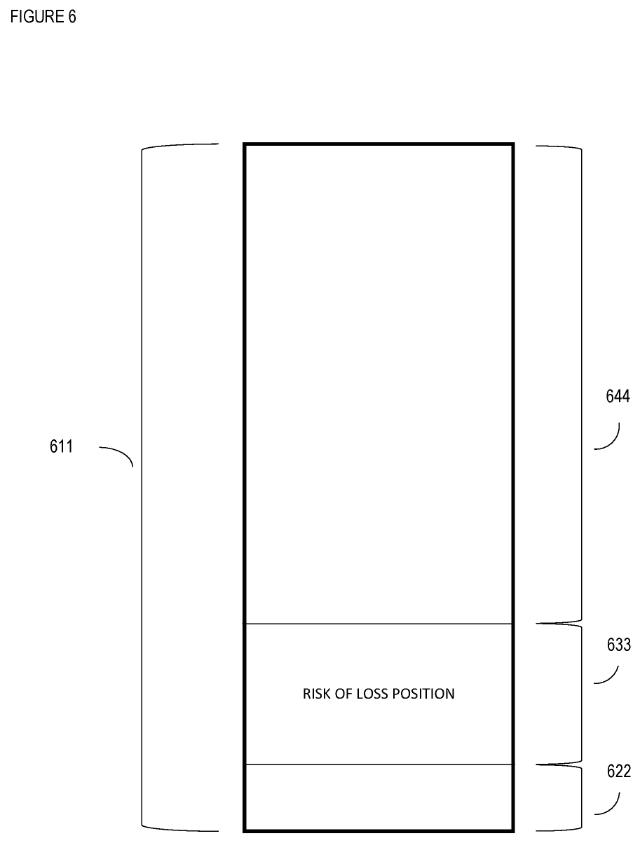

Referring to FIG. 6, a vertical illustration of USD 100 billion of identified risk position 611 that a purchaser of protection may seek to hedge the risk of loss, in whole or in part, in accordance with certain embodiments of the invention. The purchaser of protection illustrated here may be a substantial city in the United States of America at risk for imminent, unpredictable and uncontrollable risk of loss, a USD 100 billion of identified risk position 611, that such city government desires to hedge the USD 100 billion of risk of loss 611 and multiple providers of protection may undertake USD 25 billion risk of loss 633, in exchange for a risk protection premium. With respect to the characteristics of events, imminent, unpredictable and uncontrollable risk of loss, identified risk of loss position 611, the asset classes, the clearly delineated geographic region may be identified as the legal limits of the City, including the State, Zip Code, Country, the providers of protection, while undertaking USD 25 billion risk of loss 633, desire to exclude certain infrastructure, in accordance with certain embodiments of the invention, notably the largest bridge and the international airport located in the legal limits of the geographic region identified, from any risk of loss. In the event the purchaser of protection experiences a loss, the providers of protection are responsible for USD 25 billion risk of loss 633, a risk of loss amount of USD 10,000,000,000.01 up to USD 35,000,000,000.00, but not in excess of risk of loss 633 and not including any loss related to the city's largest bridge and the international airport. In taking USD 25 billion risk of loss 633, the providers of protection, may not preclude the purchaser of protection from seeking to hedge other unhedged risk of loss positions, either risk of loss position 622, a risk of loss position from USD 0.01 to USD 10,000,000,000.00 or risk of loss position 644, a risk of loss position from USD 35,000,000,000.01 to USD 100,000,000,000.00, in whole or in part, with other potential providers of protection. One of ordinary skill in the art should appreciate that the systems and methods of the invention, to provide Systems and Methods to Hedge the Risk of Loss Associated With the Imminent, Unpredictable and Uncontrollable Characteristics Inherent In Catastrophic Events, may be practiced in embodiments other than those illustrated herein without departing from the spirit and scope of the invention.

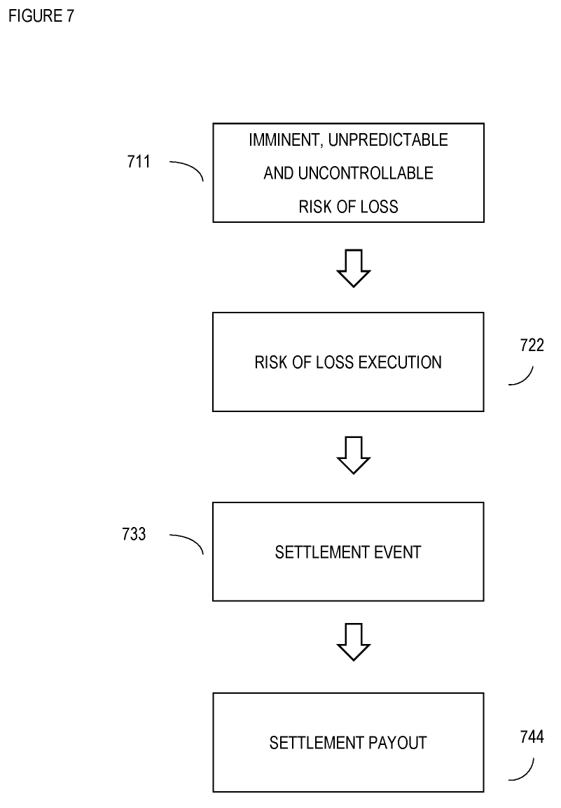

Referring to FIG. 7, a block diagram of a method that may be used to implement the processes and functions of certain embodiments of the invention.

At step 711, Imminent, Unpredictable and Uncontrollable Risk of Loss, any authorized purchaser of protection, provider of protection and intermediaries will have access to the complete pertinent details of risk of loss, as previously identified herein, including, but not limited to, the proposed economics and risk/reward of the risk of loss or models thereof that a purchaser of protection and a provider of protection may require to make timely, accurate and informed decisions regarding their interest and ability to enter into transactions related to such risk of loss.

At step 722, Risk of Loss Execution, any authorized purchaser of protection and provider of protection may enter into a transaction related to such risk of loss in electronic mode or through brokers or traders, including open outcry, on a trading floor, and/or telephone trading, in accordance with specific terms agreed to by both parties on an effective date. Such specific terms agreed to by both parties may be governed by the unique, considerable and/or specific modifications and amendments to the pre-approved documents, agreements, schedules and confirmations associated with the invention, Systems and Methods to Hedge the Risk of Loss Associated With the Imminent, Unpredictable and Uncontrollable Characteristics Inherent In Catastrophic Events, including the processing of the transaction with the clearing center and payment of the agreed upon risk of loss protection premium by the purchaser of protection to the provider of protection and any margin and/or margin calls, if any, as required.

At step 733, Settlement Event, should it be determined that the purchaser of protection has incurred a loss that the provider of protection is responsible for, such determination shall be pursuant to specific terms agreed to by both parties on the effective date and may include a statement from the purchaser of protection legal counsel and/or a third-party loss confirmation or verification, such as a trustee or special adjuster, to research such loss and opine as to the loss incurred by the purchaser of protection, the risk of loss incurred by the provider of protection, such risk of loss to have occurred on or before the termination or maturity date of the transaction, shall be calculated and the parties notified of the result of the risk of loss calculation of their responsibility of a settlement payment pursuant to the specific terms agreed to by both parties. In the event that it is determined that no settlement event has occurred prior to the termination or maturity date of the transaction, the transaction is terminated.

At step 744, Settlement Payment, if it is determined that a settlement payment is due to the purchaser of protection by the provider of protection, such settlement payment may be paid by the provider of protection and may be cleared through a clearing house.

One of ordinary skill in the art should appreciate that the systems and methods of the invention, to provide Systems and Methods to Hedge the Risk of Loss Associated With the Imminent, Unpredictable and Uncontrollable Characteristics Inherent In Catastrophic Events, may be practiced in embodiments other than those illustrated herein without departing from the spirit and scope of the invention.

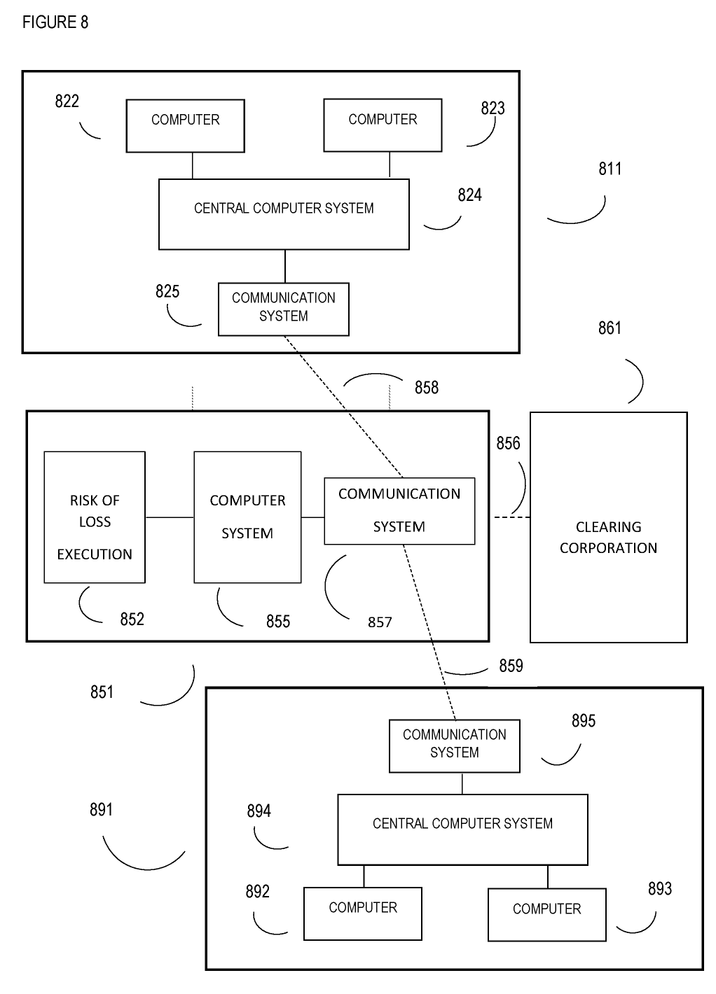

Referring to FIG. 8, a block diagram of systems 851, 811, 891 and including clearing corporation 861, is an illustration showing how the invention, Systems and Methods to Hedge the Risk of Loss Associated With the Imminent, Unpredictable and Uncontrollable Characteristics Inherent In Catastrophic Events, may be implemented.

Risk of loss information management system 851 may provide approved users, such as purchaser of protection information management system 811, provider of protection information management system 891, and clearing corporation 861, with the ability to share certain resources, including information pertinent to and necessary to market, evaluate, analyze, monitor, value, manage and execute the risk of loss transactions and clear such risk of loss transactions.

Risk of loss information management system 851, communication system 857, which may include a modem or other similar devices that may be deemed acceptable, and risk of loss execution 852, among other devices, may be networked together by way of a local area network, a wide area network, intranet, the internet or other wired and/or wireless interconnects and/or network adapters that may be deemed acceptable, to share certain resources, such as processors, memory, data, software, communication protocol, and information, including information pertinent to, and necessary to market, evaluate, analyze, monitor, value, manage and execute the risk of loss transactions with risk of loss execution 852, and the clearing of transactions by way of communication system 857 to communicate with clearing corporation 861 by way of communication media link 856, which may be cables, telephone lines, cellular radio, intranet, the internet, satellites, other wired and/or wireless interconnects and/or network adapters and/or modes of communication deemed suitable. Risk of loss execution 852 may be comprised of mid-range servers, personal digital assistants, handheld computers, desktop computers, personal computer, laptop computer, workstations or other devices deemed suitable for such function.

Communication system 857 may be linked to communication systems 825 and communication system 895 by way of communication media links 858 and communication media link 859, communication system 857, may share certain resources, such as processors, memory, data, software, communication protocol, and information, including information pertinent to, and necessary to market, evaluate, analyze, monitor, value, manage and execute risk of loss transactions as well as clear transaction by the way of communication media link 856 and clearing corporation 861.

Purchaser of protection computer terminals 822 and 823, and provider of protection computer terminals 892 and 893 may comprise mid-range servers, personal digital assistants, personal computers, laptop computers, handheld computers, desktop computer and workstations, with the ability to share certain resources, including information pertinent to, and necessary to market, evaluate, analyze, value, monitor, manage and execute the risk of loss transactions with risk of loss execution 852 and the clearing of risk of loss transactions with clearing corporation 861.

Communication system 825, communication system 857 and communication system 895 may communicate by way of communication media link 858, communication media link 859 and communication media link 856, which may be cables, telephone lines, cellular radio, intranet, the internet, satellites or other wired and wireless interconnects and network adapters and/or modes of communication that may be deemed acceptable.

Purchaser of protection's information management system 811 may consist of central computer system 824 that may be comprised of central processing units, mainframes, super computers, memory, data storage devices, system software, communication protocol, application software, devices, related electronics and other computer hardware and software that may be deemed acceptable and may be networked with communication system 825 and computer terminals 822 and 823 by way of a local area network, a wide area network, intranet, the internet and/or other wired or wireless interconnects and network adapters and other modes that may be deemed acceptable, may allow users, such as computer terminals 892 and 893, to share certain information pertinent to, and necessary, to market, evaluate, analyze, monitor, value, manage and execute risk of loss transactions.

Provider of protection's information management system 891 may consist of central computer system 894 that may be comprised of central processing units, mainframes, super computers, memory, data storage devices, system software, communication protocol, application software, devices, related electronics and other computer hardware and software that may be deemed acceptable and may be networked with communication system 895 and computer terminals 892 and 893 by way of a local area network, a wide area network, intranet, the internet and/or other wired and wireless interconnects and network adapters and other modes that may be deemed acceptable, may allow users, such as computer terminals 892 and 893, to share certain information pertinent to, and necessary, to market, evaluate, analyze, monitor, value, manage and execute risk of loss transactions.

Provider of protection's information management system 891, by way of computer terminals 892 and/or 893, which may also be comprised of mid-range servers, personal computers, laptop computers, personal digital assistants, handheld computers and workstations, may share resources, such as central computer system 894, which may include processors, memory, data, software, communication protocol, and information, networked by way of local area network, wide area network, intranet, internet and/or wired and wireless interconnects and network adapters and other modes, by communication system 895, which may include a modem or other modes, and may be linked to communication system 857 by way of communication media link 859 which may be cables, telephone lines, cellular radio, intranet, the internet, satellites and/or other wired and wireless interconnects and network adapters and other communication modes deemed acceptable.

Central computer system 894 may be comprised of central processing units, mainframes, super computers, memory, data storage devices, system software, communication protocol, application software, devices and the related electronics which may be networked with communication system 895 and computers 892 and 893.

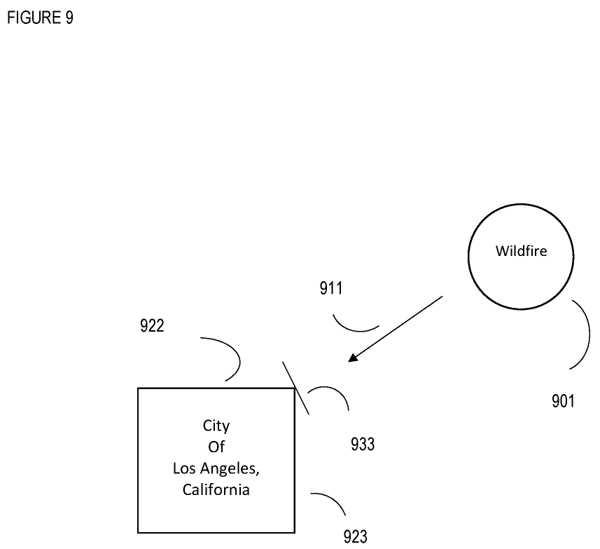

Referring to FIG. 9, a diagram of a risk of loss position that is predicated on simply some occurrence of specific catastrophic events. A purchaser of protection may seek to hedge the risk of loss should a specific catastrophic event, wildfire 901, fueled by the Santa Ana winds 911, present a risk of loss to the City of Los Angeles, Calif., by spreading to and breaching the legal city limits of Los Angeles. The northern legal city limits of Los Angeles is depicted in the top line 922, the eastern legal limits of Los Angeles is depicted in right line 923 and the northeast legal city limits of Los Angeles 933 is depicted closest to the catastrophic event. The purchaser of protection may desire to hedge the risk of loss by a predetermined USD 1 billion of risk of loss and the provider of protection may undertake the predetermined USD 1 billion in risk of loss, in exchange for earning a risk protection premium for undertaking such risk of loss. Should it be determined that wildfire 901 breaches the legal city limits of the City of Los Angeles, Calif., the provider of protection is responsible for a risk of loss of USD 1,000,000,000.00, but not in excess of the predetermined risk of loss.

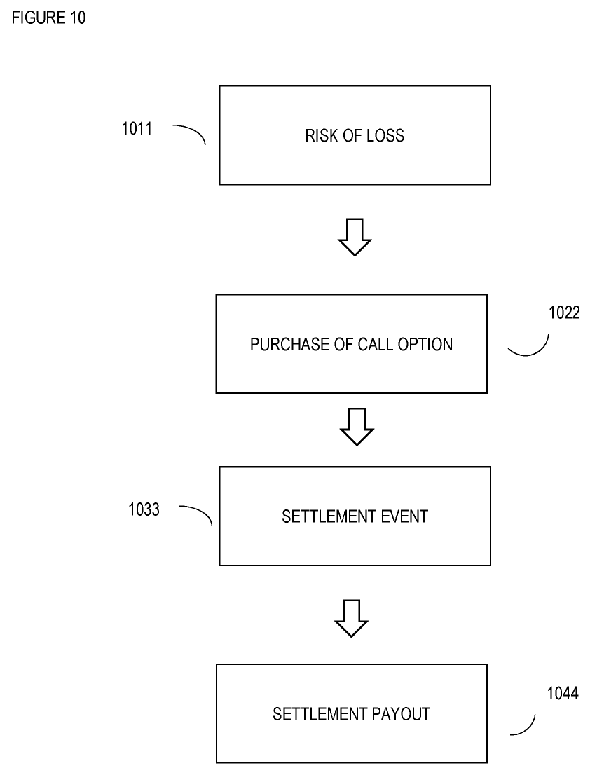

Referring to FIG. 10, a block diagram of the processes and functions of a call option.

At step 1022, a purchaser of protection for payment of an initial premium, decides to purchase a call option from a provider of protection, perhaps as a bet that the cost to hedge risk of loss 1011 with respect to a particular catastrophic risk and asset class, among other embodiments of the invention, may rise in value in the near future, in relation to the strike price of the call option and any related costs.

At step 1033, providing the purchaser of protection is correct and the option is in the money, prior to the expiration date, the purchaser of protection may exercise the call option, at the predetermined strike price in step 1022, a lower price, and profit from the arbitrage at the settlement payout step 1044, from the provider of protection. Alternatively, the purchaser of protection may sell the call option, preferably for a profit. The call option provides the purchaser of protection the right, but not the obligation to purchase protection at the strike price. the call option gives you the right, but not the obligation, to purchase

One of ordinary skill in the art should appreciate that the systems and methods of the invention, to provide Systems and Methods to Hedge the Risk of Loss Associated With the Imminent, Unpredictable and Uncontrollable Characteristics Inherent In Catastrophic Events, may be practiced in embodiments other than those illustrated herein without departing from the spirit and scope of the invention.

What is claimed is:

1. A method providing one the ability to eliminate exposure to the risk of loss and another the ability to incur exposure to such risk of loss, such risk of loss to a geographic location; in a time sensitive environment, due to the imminent, unpredictable and uncontrollable innate characteristics that are inherent in existing catastrophic events, those that occur in a very quick time, that which is unpredictable with a high degree of certainty, that which behaves in an unforeseeable way, and that of which is unmanageable; such method, comprises, an electronic device, that processes real-time, near real-time or the most recently available information relating to the imminent, unpredictable and uncontrollable innate characteristics that are inherent in catastrophic events, thereby, providing a means to instantaneously present such information, in electronic form, to one that may desire to eliminate exposure to the risk of loss due to the imminent, unpredictable and uncontrollable innate characteristics that are inherent in catastrophic events, and another that may desire to incur exposure to the risk of loss due to the imminent, unpredictable and uncontrollable innate characteristics that are inherent in catastrophic events; such electronic device providing the means to instantaneously evaluate, analyze, monitor, value, manage, and market such risk of loss, in such a time sensitive environment; and an instrument, such instrument, a means for one to eliminate exposure to the risk of loss and another to incur exposure to the risk of loss, such risk of loss, to a geographic location, in a time sensitive environment, due to the imminent, unpredictable and uncontrollable innate characteristics that are inherent in catastrophic events.

2. The method in claim 1 wherein the risk of loss to a geographic location, comprises, the legally defined boundaries of a Country, a Territory, a Republic, a State, a District, a County, a Parish, a City, a Township, or a Municipality.

3. The method in claim 2 wherein the risk of loss to a geographic location, comprises, the legally defined boundaries or any precisely defined area or a particular extent of surface or space on the Planet Earth.

4. The method in claim 2 wherein the risk of loss to a geographic location comprises asset classes within such geographic location, comprising, commercial real estate, residential real estate, personal property and infrastructure.

5. The method in claim 2 wherein the risk of loss to a geographic location, comprises, specific assets, specific infrastructure or specific property within such geographic location.

6. The method in claim 1 wherein the risk of loss due to the innate characteristics inherent in catastrophic events, should it be determined that a loss occurred, such loss, comprises, the actual loss associated with or damage to a geographic location that is a direct result of the innate characteristics inherent in catastrophic events, resulting in the financial burden of bearing the monetary cost associated with the restoration and repair of damage to or within the geographic location.

7. The method in claim 6 wherein the risk of loss due to the innate characteristics inherent in catastrophic events, should it be determined that an loss may have occurred, comprises, a claim process to determine such loss or the actual loss associated with or damage to or within a geographic location that is a direct result of the innate characteristics inherent in catastrophic events, resulting in the financial burden of bearing the monetary cost associated with the restoration and repair of damage to or within the geographic location.

8. The method in claim 6 wherein the risk of loss due to the innate characteristics inherent in catastrophic events, should it be determined that an loss occurred, such loss, comprises, the actual destruction of an asset class, assets, infrastructure or property; a loss that is a direct result of the innate characteristics inherent in catastrophic events, resulting in the financial burden of bearing the monetary cost associated with the restoration, repair or replacement of the asset class, assets, infrastructure or property.

9. The method in claim 6 wherein the risk of loss due to the innate characteristics inherent in catastrophic events, should it be determined that a loss occurred, such loss, comprises, the disaster and recovery assistance provided to impacted communities, parties, entities or individuals, a direct result of the innate characteristics inherent in catastrophic events.

10. The method in claim 1 wherein the risk of loss due to the innate characteristics inherent in catastrophic events, should it be determined that a loss occurred, such loss, comprises, a pre-determined amount that may be predicated on the occurrence of a catastrophic event.

11. The method in claim 1 wherein the imminent, unpredictable and uncontrollable innate characteristics that are inherent in catastrophic events, comprises, identified, existing catastrophic events identified by name, an identification code, or a known name.

12. The method in claim 11 wherein the imminent, unpredictable and uncontrollable innate characteristics that are inherent in catastrophic events, comprises, identified, existing catastrophic events, identified by name, an identification code, a known name, or the like.

13. The method in claim 11 wherein the imminent, unpredictable and uncontrollable innate characteristics that are inherent in catastrophic events, comprises, catastrophic events that are believed to be imminent.

14. The method in claim 1 wherein the real-time, near real-time or most recently available information associated with the imminent, unpredictable and uncontrollable innate characteristics that are inherent in catastrophic events, comprises, information pertinent to the Planet Earth's oceans, weather and environment, and the weather and the activity of our Solar System.

15. The method in claim 14 wherein the real-time, near real-time or most recently available information associated with the imminent, unpredictable and uncontrollable innate characteristics that are inherent in catastrophic events, the Planet Earth's oceans, weather and environment, and the weather and the activity of our Solar System, comprises, real-time, near real-time or the most recently available information, comprising, sea surface temperatures, sub-sea surface temperatures, the composition of sea water, atmospheric temperatures, the levels of temperatures throughout the troposphere, atmospheric moisture, rates of rainfall, levels of moisture throughout the troposphere, land surface temperatures, the intensity change to the internal dynamical factors of storm systems, the dynamic instability of the eyewall potential vorticity annulus, its breakdown and subsequent eddy flux of potential vorticity annulus from the eyewall into the eye, cloud layers, the height of clouds, the cloud top pressures, cloud top temperatures in proximity to storm systems, the depth of clouds, the particles in clouds, the size of particles in clouds, the moisture in clouds, the cloud patterns in proximity to storm systems, the moisture in atmospheric columns, the sea ice concentration in oceans, change in the sea ice covered area of oceans, the motion of water vapor in clouds, the motion of cloud features, lightning flashes, lightning events, the area of lightning groups, the degree of snow cover, the level of radiation in the atmosphere, the level of radiation exiting the atmosphere, the level of carbon dioxide in the atmosphere, the change in the degree of carbon dioxide in the atmosphere, hot spots, fires, wind speeds, the height of volcanic ash, the mass of volcanic ash, the presence of aerosols in the atmosphere, radiances, aircraft visual reconnaissance data, ocean wave height, the degree of change in ocean wave height, algal blooms, the degree of cloudiness in the sky, sea level pressures, surface wind speeds, seismic activity, the movement of tectonic plates, the movement of magma, the change in the degree of the movement of magma, the dispensing of volcanic gas, the change in the degree of volcanic gas dispensed, the procession of earthquakes, the magnitude of earthquakes, the degree of change in the magnitude of earthquakes, tremors, surface changes on a volcano, the development of lava lakes on a volcano, surface changes in the immediate surrounding area of a volcano, the increase in the degree of rumbling of a volcano, magma raising from a volcano, the viscosity of magma rising from a volcano, the degree of silica in the magma rising from a volcano, the degree of pressurized gases released from the fumaroles of a volcano, the degree of the temperature of the gases released from a volcano, the radiation of compressional (P) waves and transverse (S) waves outward from the epicenter of an earthquake, the probability of exceeding levels of historical ground shaking, the probability, magnitudes and locations of earthquakes, ground motion detections from regional seismic stations, space weather, the eruption of gas and particles from the Sun's corona, solar wind, changes in solar wind, radiation emitted from the Sun into space, the degree of radiation emitted into space, the degree of the electrical charge of particles from the Sun's corona, solar wind blasts, the degree of solar wind blasts, auroras from charged particles emitted from the Sun, the degree of the auroras, solar flares from solar storms, solar eruptions or coronal mass ejections, and the effect of the weather and activity of our Solar System on the atmosphere.

16. The method in claim 14 wherein, the real-time, near real-time or most recently available information associated with the imminent, unpredictable and uncontrollable innate characteristics that are inherent in catastrophic events, the Planet Earth's oceans, weather and environment, and the weather and the activity of our Solar System, comprises, data, observations, estimations, projections, calculations, analysis, imagery and measurements.

17. The method in claim 14 comprises, a means, in a time sensitive environment, for one to evaluate, analyze, monitor, value, manage, market, transact, eliminate and incur exposure to the risk of loss due to the imminent, unpredictable and uncontrollable innate characteristics that are inherent in catastrophic events.

18. The method in claim 1 wherein the imminent, unpredictable and uncontrollable innate characteristics that are inherent in catastrophic events that present a risk of loss, comprises, cyclonic storms, cyclones, tropical cyclones and hurricanes.

19. The method in claim 1 wherein the imminent, unpredictable and uncontrollable innate characteristics that are inherent in catastrophic events that present a risk of loss, comprises, storm systems, tropical storms, typhoons, floods, blizzards, hail storms, ice storms, dust storms, tropical depressions, post-tropical cyclones, nor'easters, winds, wind storms, storm surge, tornadoes, tsunamis, wildfires, earthquakes, volcanic eruptions, and electromagnetic pulses.

20. The method in claim 1 wherein the imminent, unpredictable and uncontrollable innate characteristics that are inherent in the catastrophic events that present a risk of loss to a geographic location, those that occur in a very quick time, that which is unpredictable with a high degree of certainty, that which behaves in an unforeseeable way, and that of which is unmanageable; comprises, an instrument, such instrument identifying one that may desire to eliminate exposure to the risk of loss due to the imminent, unpredictable and uncontrollable innate characteristics that are inherent in catastrophic events; a risk of loss to a geographic location; such risk of loss, in whole or in part; a notional value; such instrument, that grants one, that may desire to eliminate exposure to the risk of loss due to the imminent, unpredictable and uncontrollable innate characteristics that are inherent in catastrophic events, the right to receive a settlement amount; such settlement amount according to a settlement payment schedule; an expiration date; such settlement amount to be paid by another, that may desire to incur exposure to the risk of loss due to the imminent, unpredictable and uncontrollable innate characteristics that are inherent in catastrophic events to the risk of loss to an identified catastrophic risk.

21. The method in claim 20 wherein, such risk of loss to a geographic location, comprises, the risk of loss to an identified asset class, such risk of loss to assets, infrastructure or property, in its entirety or in part.

22. A method providing one the ability to eliminate exposure to the risk of loss and another the ability to incur exposure to such risk of loss, such risk of loss to a geographic location; to an asset class; to assets, infrastructure and property; due to the imminent, unpredictable and uncontrollable innate characteristics that are inherent in catastrophic events, those that occur in a very quick time, that which is unpredictable with a high degree of certainty, that which behaves in an unforeseeable way, and that of which is unmanageable; such method, comprises, granting one the right to obtain protection to the risk of loss due to the imminent, unpredictable and uncontrollable innate characteristics that are inherent in catastrophic events, but not the obligation; such granting one the right, by another; and the granting one the right to dispose of exposure to the risk of loss due to the imminent, unpredictable and uncontrollable innate characteristics that are inherent in catastrophic events, but not the obligation, such granting one the right, by another.

23. The method in claim 1, comprises, one who is seeking to eliminate exposure to the risk of loss due to the imminent, unpredictable and uncontrollable innate characteristics that are inherent in catastrophic events; is granted the right to obtain protection from the risk of loss, but not the obligation, pursuant to such instrument, such right to obtain protection, granted by another, that desires the ability to incur such exposure to such risk of loss, pursuant to such instrument, should one exercise such right, such granted right to be exercised within a specific time period.

24. The method in claim 23 wherein the instrument granting one the right to obtain protection from the risk of loss due to the imminent, unpredictable and uncontrollable innate characteristics that are inherent in catastrophic events, but not the obligation, pursuant to the instrument, comprises, an upfront payment, and a predetermined exercise payment, should one choose to exercise such right to eliminate exposure to the risk of loss, pursuant to the instrument.

25. The method in claim 23 wherein the instrument granting one the right to obtain protection from the risk of loss due to the imminent, unpredictable and uncontrollable innate characteristics that are inherent in catastrophic events, but not the obligation, pursuant to the instrument, comprises, an upfront payment, such upfront payment may be deferred.

26. The method in claim 1, comprises, one who is seeking to eliminate exposure to the risk of loss, due to the imminent, unpredictable and uncontrollable innate characteristics that are inherent in catastrophic events, is granted the right to dispose of such exposure, but not the obligation, pursuant to such instrument, such right, granted by another that desires the ability to incur such exposure to the risk of loss, should one exercise such right, such granted right to be exercised within a specific time period.

27. The method in claim 26 wherein the instrument granting one the right to dispose of such exposure to the risk of loss due to the imminent, unpredictable and uncontrollable innate characteristics that are inherent in catastrophic events, but not the obligation, pursuant to the instrument, comprises, an upfront payment, and a predetermined exercise payment, should one choose to exercise such right to eliminate exposure to the risk of loss, pursuant to the instrument.

28. The method in claim 26 wherein the instrument granting one the right to dispose of such exposure to the risk of loss due to the imminent, unpredictable and uncontrollable innate characteristics that are inherent in catastrophic events, but not the obligation, pursuant to such instrument, comprises, an upfront payment, such upfront payment may be deferred.

29. The method in claim 1 wherein the risk of loss to a geographic location, comprises, the ability to exclude certain assets, infrastructure or property.

30. The method in claim 1 wherein the risk of loss pursuant to the instrument is processed by a clearing operation that verifies and facilitates the exchange of payments, requirements and ensures and maintains the integrity of the obligations and activities, including financial quality of one, who desires to eliminate exposure to the risk of loss and another, who desires to incur exposure to such risk of loss, in a time sensitive environment, due to the imminent, unpredictable and uncontrollable innate characteristics that are inherent in existing catastrophic events.

31. The method in claim 1 wherein the value of such instrument, comprises, the instantaneous evaluation, observation, imagery, analysis, monitoring, and marketing of such risk of loss to a geographic location, due to the risk of loss associated with the imminent, unpredictable and uncontrollable innate characteristics that are inherent in catastrophic events, the Earth's oceans, weather, environment and the weather and the activity of our Solar System.

32. A system for providing one the means to eliminate exposure to the risk of loss and another the ability to incur exposure to such risk of loss, such risk of loss to a geographic location, in a time sensitive environment, due to the imminent, unpredictable and uncontrollable innate characteristics that are inherent in existing catastrophic events, those that occur in a very quick time, that which is unpredictable with a high degree of certainty, that which behaves in an unforeseeable way, and that of which is unmanageable, such system, comprises, an information management system to acquire data, observations, perform estimations, make projections, perform calculations, analyze imagery, perform measurements, store, make available, process and distribute the real-time, near real-time or most recently available information associated with the imminent, unpredictable and uncontrollable innate characteristics that are inherent in catastrophic events, the Planet Earth's oceans, weather and environment, and the weather and the activity of our Solar System.

33. The system in claim 32 wherein the information management system, comprises, a central processing unit, memory, data storage devices, communication systems and computer terminals, to provides one, who desires the means to eliminate exposure to the risk of loss and another, who desires the means to incur exposure to such risk of loss, the real-time, near real-time or most recently available information associated with the imminent, unpredictable and uncontrollable innate characteristics that are inherent in catastrophic events, the Planet Earth's oceans, weather and environment, and the weather and the activity of our Solar System.

34. The system in claim 32 wherein the information management system, comprises, devices, related electronics and other computer hardware that may be deemed acceptable and may be networked with the communication system and computer terminals, providing one, who desires the ability to eliminate exposure to the risk of loss and another, who desires the ability to incur exposure to such risk of loss, the real-time, near real-time or most recently available information associated with the imminent, unpredictable and uncontrollable innate characteristics that are inherent in catastrophic events, the Planet Earth's oceans, weather and environment, and the weather and the activity of our Solar System, utilizing computer terminals to share information pertinent to and necessary to market, evaluate, analyze, monitor, value, manage and obtain the desired risk of loss positions.

35. The system in claim 32 wherein the information management system, comprises, the system software, communication protocol, application software, and other computer and communication software that may deemed acceptable, providing one, who desires the means to eliminate exposure and another, who desires the means to incur exposure to such risk of loss, the real-time, near real-time or most recently available information associated with the imminent, unpredictable and uncontrollable innate characteristics that are inherent in catastrophic events, the Planet Earth's oceans, weather and environment, and the weather and the activity of our Solar System, utilizing computer terminals to share information pertinent to and necessary to market, evaluate, analyze, monitor, value, manage and obtain the desired risk of loss positions.

36. The system in claim 32 wherein the information management system obtains, processes and provides the information, data, observations, imagery, calculations, analysis, projections, measurements and analysis that are pertinent to such risk of loss, the real-time, near real-time or most recently available information associated with the imminent, unpredictable and uncontrollable innate characteristics that are inherent in catastrophic events, the Planet Earth's oceans, weather and environment, and the weather and the activity of our Solar System.

37. The system in claim 32 wherein the information management system, comprises, a plurality of computer terminals that are adapted to electronically display the information, consisting, of data, observations, imagery, calculations, analysis, projections, measurements and analysis, providing one, who desires the ability to eliminate exposure to the risk of loss and another, who desires the ability to incur exposure to such risk of loss, the real-time, near real-time or most recently available information associated with the imminent, unpredictable and uncontrollable innate characteristics that are inherent in catastrophic events, the Planet Earth's oceans, weather and environment, and the weather and the activity of our Solar System.

38. The system in claim 32 wherein the information management system, comprises, a plurality of computer terminals that are adapted to send and receive a command providing one, who desires the means to eliminate exposure to the risk of loss and another, who desires the means to incur exposure to such risk of loss, in a time sensitive environment, due to the imminent, unpredictable and uncontrollable innate characteristics that are inherent in existing catastrophic events, such means, and such commands that are processed by the information management system to share information pertinent to and necessary to market, evaluate, analyze, monitor, value, manage and obtain the desired risk of loss positions.

39. The system in claim 32 comprising of an information management system, a means to verify and facilitate the exchange of payments, requirements and ensure and maintain the integrity of the performance obligations and activities, including the financial quality, of one, who desires the means to eliminate exposure and another, who desires the means to incur exposure to such risk of loss, to a geographic location, in a time sensitive environment, due to the imminent, unpredictable and uncontrollable innate characteristics that are inherent in catastrophic events, such commands that are processed by the information management system. the verification, requirements and completion of one to eliminate exposure from the risk of loss and another to incur the risk of loss, in a time sensitive environment, due to the imminent, unpredictable and uncontrollable innate characteristics that are inherent in catastrophic events from the time such instrument is effective and until the expiry.

40. The system in claim 32 comprising of an information management system coupled to another information management system, providing a means to verify and facilitate the exchange of payments, requirements and ensure and maintain the integrity of the obligations and activities, including financial, of one, who desires the means to eliminate exposure and another, who desires the means to incur exposure to such risk of loss, in a time sensitive environment, due to the imminent, unpredictable and uncontrollable innate characteristics that are inherent in existing catastrophic events, such commands that are processed by the information management system. the verification, requirements and completion of one who desires to eliminate exposure to the risk of loss and another to incur the risk of loss, in a time sensitive environment, due to the imminent, unpredictable and uncontrollable innate characteristics that are inherent in catastrophic events from the time such instrument is effective and to the expiry.
